(19) United States
(12) Patent Application Publication
(10) Pub. No.: US 2001/0034843 A1
(43) Pub. Date: Oct. 25, 2001

(54) Method of transferring information over a computer network

(76) Inventor: Daniel Hess, Wheaton, MD (US)

Correspondence Address: John G. Posa, GIFFORD, KRASS, GROH, SPRINKLE,, PATMORE, ANDERSON & CITKOWSKI, P.C., 280 N. Old Woodward Ave., Suite 400, Birmingham, MI, 48009, US

(21) Appl. No.: 09/761,458

(22) Filed: Jan. 16, 2001

Related U.S. Application Data
(60) Provisional application No. 60/176,459, filed on Jan. 15, 2000.

(51) Int. Cl. H04L 9/00

(52) U.S. Cl. 713/201

(57) ABSTRACT

A user seeking to transfer files, folders or other information to a second user can do so in a simple two-step process. The user first selects the files/folders to be transferred, and then enters an e-mail address of the destination user. The files and/or folders are packaged together in an archive, which is automatically held on a server, and a message is sent to the destination user containing an encoded http link to retrieve the file. This links is a special one-time user link that expires after the file has been downloaded. The receiver runs the file, which self extracts the files and/or folders into a destination folder of the receiver's choice. This system makes the process of moving files and folders from one computer to another simpler and overcomes critical ease-of-use issues.

### REFERENCE TO RELATED APPLICATION

This application claims priority from U.S. provisional application Ser. No. 60/176,459, filed Jan. 15, 2000, the entire contents of which is incorporated herein by reference.

### FIELD OF THE INVENTION

This invention relates generally to information transfer over a computer network and, in particular, to a simplified process whereby a sender may deliver files, folders, directories and other such information to a recipient by way of an intranet or Internet connection.

### BACKGROUND OF THE INVENTION

Currently, there are several ways that are commonly used by computer users to send files and folders to other users. Each has certain drawbacks, however.

### Email as an Attachment

According to this method, the sender sends the receiver an email message with files attached, either individually or bundled together in an archive and attached as a single file. When the receiver gets the email message, the attached files are included, provided that the user's mail server accepted them.

This approach has several weaknesses. One is that large items can usually not be sent by email attachment because most mail servers reject files larger than a certain size (generally several megabytes). A second problem is that files included as attachments are generally encoded (using Mime, BinHex, or Uuencode to name a few), making them larger in transit, thereby slowing the transfer. If a folder/directory is to be sent, the user must create an archive package manually using one of the common archiving programs, and the recipient must be able to open this archive. Many Internet users do not even know how to use these archive programs. In addition, the receiver of the message does not have much control over receiving the file. It is pushed to them when they download their messages. They may blindly cancel the download, but then they won't know what they missed. Lastly, some text-based email systems do not even permit viewing or retrieving of attachments. If the receiver uses one of these systems, they will not be able to receive the message.

### Upload to an http or ftp Server

According to this approach, the sender logs in to an http or ftp server where they have an account. They then upload files, either individually or bundled together in an archive, to an http or ftp server. The sender provides the receiver with a URL, in the case of an http server, or an address and login information, in the case of an ftp server. The receiver then accesses the server and retrieves the items.

This approach has the benefit that larger files and folders can be transferred compared to other methods, and the receiver has control over the download of the files. The drawbacks are mainly related to ease-of-use. The sender must have an account on a server, and must log in, typically via ftp, to upload to it. The sender must also use an archive program to package the data and the receiver may have to use a similar program to unpack them. Further, additional measures may have to be taken to ensure that the receiver only has access to what has come from the sender and not other data that may reside on the server.

### Transfer Across a LAN

Many operating systems, including Microsoft Windows, allow transfers across shared partitions on a local area network (LAN), often by simple drag and drop. This is fast and convenient where possible. However, most users are not connected to each other in this way.

### Use of Portable Storage

Commonly, devices such as floppy disks. Zip disks, or writable CDs will be used for transfer of data. Though this approach is non-instantaneous, requires physical transport, and is subject to hardware failure, many use it because it's the least complicated option.

### Run an http or ftp Server Locally

Among the more technically savvy users, this is a common approach. The sender can serve the files through the server and provide the receiver with an address to access the files. Unfortunately, most users do not know how to run a server, or have a permanent connection to allow the server to be always accessible.

### Allow Remote Login To Your Computer

Some operating systems including Unix-based systems allow remote login and access across a network. By giving a user remote access, one user can let another user retrieve their files. However, this approach raises security questions. Also, only a small percentage of computer users use operating systems that allow such procedures.

### SUMMARY OF THE INVENTION

This invention improves upon the prior art by allowing a computer user to send files and/or folders (directories) to another user using a simple two-step process, without the difficulties and limitations of current file-Transfer methods. Using the invention, the sender, running a special application program, simply indicates the files and/or folders being transferred and then specifies an email address of the user that is to receive the items, and clicks ‘send’. The recipient receives a message that contains a link to the file (is there is only one) or to an auto-expanding archive file, which recreates the items upon execution.

When the sender clicks ‘send,’ the application program running on their system creates a self-expanding archive, and transmits it across the Internet to a server, which stores it until the receiver successfully downloads it. The receiver gets a message, via email or some other messaging system, which includes a special encoded http link to the file. The user simply clicks this link to download the file, and expands the archive to complete the process.

This method fixes many of the problems in existing ways of transferring files. There is no hard limit on how much data a user could transfer. Folders are easily transferred without the use of additional software. Also, the receiver can pull the file as they would like, at their own convenience. They may pass the link to another user without having to download or upload any files. If the receiver is using a text-based email program, they can still obtain the link and retrieve the file. And there is no risk that the recipient could access unauthorized files because they only receive an encoded link to that which the sender has transmitted.

### BRIEF DESCRIPTION OF THE DRAWINGS

FIG. 1 is a screen display of the interface for selecting files/folders to send to another user through the computer desktop;

FIG. 2 is a screen display of the interface for selecting files/folders to send to another user through a web browser;

FIG. 3 is a screen display of the main menu of the enabling application running on the sender's computer;

FIG. 4 is a screen display of the interface for selecting files/folders to send to another user from within the enabling application;

FIG. 5 is a screen display of the dialog box in which a user enters the email address of the receiving user;

FIG. 6 is an example of the message that is received by the receiving user;

FIG. 7 is a screen display showing the selection of a local destination for received files/folders; and

FIG. 8 is a flow chart depicting communication and data transfer during the transfer process.

### DETAILED DESCRIPTION OF THE INVENTION

In the preferred embodiment of this invention, a user (the sender) seeking to transfer files and/or folders to a second user (the receiver) can do so using a simple two-step process. The user first selects the files/folders to be transferred, and then, in a dialog window that appears, enters an email address of the destination user. The files and/or folders are packaged together in an archive, which is automatically held on a server, and a message is sent to the destination user containing an encoded http link to retrieve the file. This link is a special one-time use link that expires after the file has been downloaded.

Referring first to FIG. 8, the sender initiates the file transfer process by making a request 40 to an application program 42 running on the sender's computer 41 indicating which files and/or folders (directories) are to be transferred. There are several ways that user can make this request, which are discussed below. In the dialog box that appears (FIG. 5) the items that the user wishes to transfer are shown 22 along with a text field in which the user can enter the email address of the destination user 25. When the user clicks send 27 in this interface, the application program retrieves the items from the sender's local file system 43 and uses them to build an archive 44 that will bundle files and folders together and preserve the file hierarchy within them, as well as compressing files to the extent possible. The application then sends this archive, as well as sender and receiver information, across the Internet or intranet to a central server 46.

The central server stores the archive file locally in its file system. In addition, it assigns this file a unique file id and stores a record consisting of sender and receiver info, file id, and the location of that file on the server. The server sends a message 47 to the receiver that includes an http link to the server with the file id embedded in an encoded format. On receiving the message, the receiver clicks on the link 50 sending a request for that file to the server. The server sends the self-expanding archive to the receiver 51. On completion of the transfer, the server sends a message back to the application program 42 indicating the successful transfer of the file. Later, if the sender checks on the status of the transfer in the application program, they will see that it has been transferred successfully. The file is removed from the server system.

On receiving and opening the file they have just received, the receiver is prompted to select a destination for the files and folders (FIG. 7). An interface 34 allows the user to select the drive and folder where the folders will be placed in locally. Upon clicking a submit button 37, the files and folders are placed on the receivers local system, and the transfer is complete.

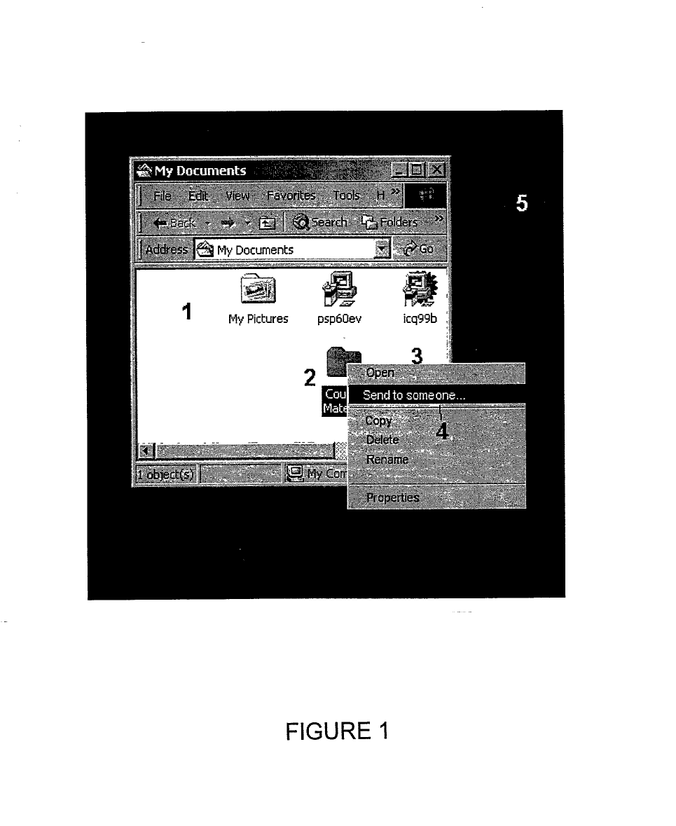

We now discuss the different ways that the sender can indicate which files to send to a receiver. Referring to FIG. 1, the sender can indicate the files to be transferred directly from the ‘desktop’ 5. The user first navigates through their file system and selects the files and/or folders that are to be transferred 2. The sender then right-clicks to bring up a menu 3. Many windows based operating systems permit this. If the user is running the application program, one of the options which will appear is a choice, ‘Send to someone’0 4. Clicking on this option will launch the application program and notify the application program of the selection.

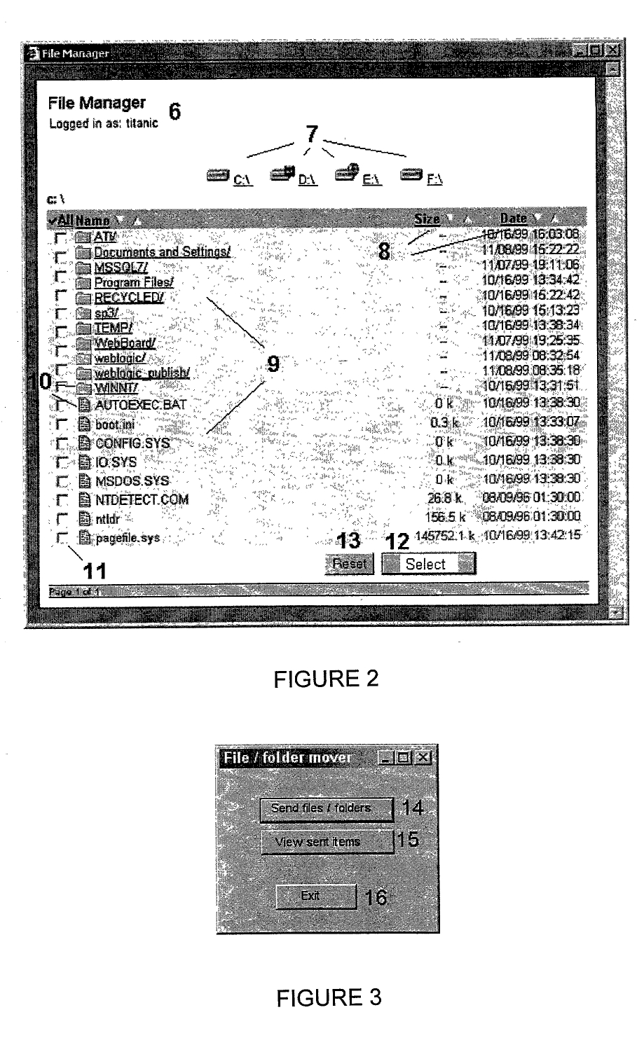

Another way the sender can indicate the items they would like to send is through a web interface (FIG. 2). In this interface, each location partition 7 can be clicked on to show a view of that partition. Folders can be clicked on to show their contents. An icon next to each file or folder listed 10 indicates whether the item is a file or folder. Checkboxes 11 appear at left, allowing users to select files and folders they want to send. Clicking ‘Select’ 12 submits the selections to the application program.

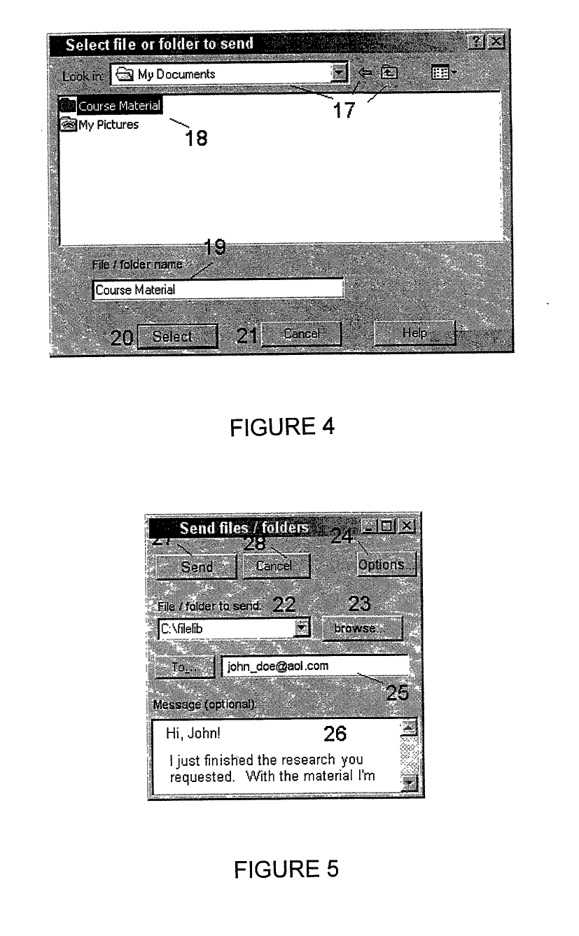

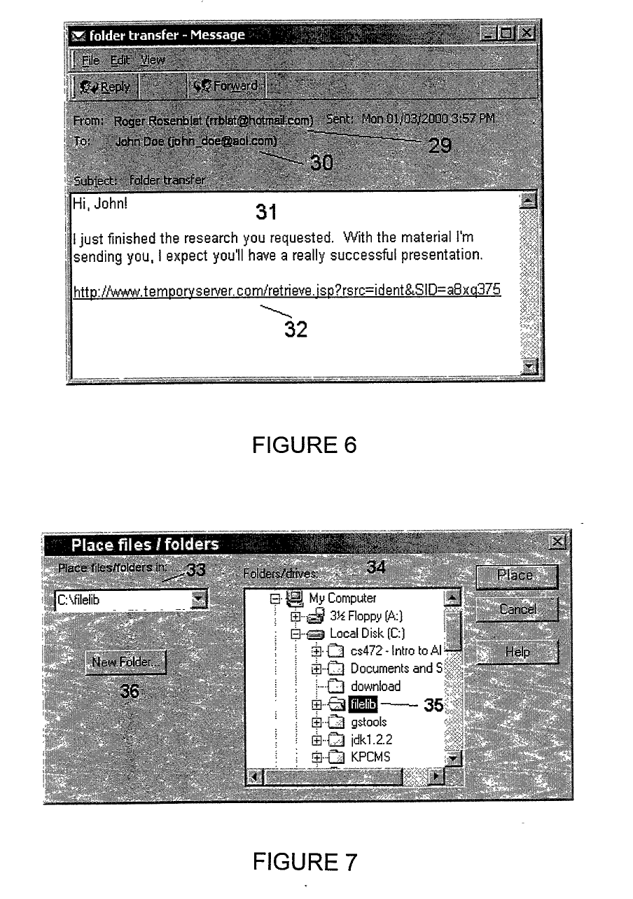

Another alternative way in which the sender may indicate the items they would like to send is by opening the local application (FIG. 3), launching the send files/folders interface 14, and clicking ‘browse’ 23. The window that appears (FIG. 4) has navigation tools 17 which allow the user to select a file or folder 18 to transfer. The selected item appears in a textbox 19. Clicking ‘Select’ 20 submits the selections to the application program.

Also, the sender can choose items to send by dragging and dropping selections onto an icon on the user's desktop, or by dragging and dropping selections onto the application window itself.

In the textbox where the user indicates the email address of the destination user 25, they may alternately enter an address associated with another messaging system. For example, the user might enter a screen name associated with the AOL Instant Messenger™ or an ICQ™ number. In this case, a message is created and sent through that system instead.

Optionally, if the sender chooses to do so, they may have their own system act as the server 46. In this case, the archive is not uploaded to the server, but held locally. A message is sent out to the receiver, but the http link to retrieve the file points to the sender's own computer. In all other respects, the process is similar.

The sender can choose to view a log of files and folders that have been transferred by selecting ‘View sent items’ 15 in the application interface (FIG. 3). A view of file transfer history, including the date and time of each transfer, destination user, contents of the transfer, and whether it was successfully retrieved are shown.

By clicking an ‘Options’ button 24, the user can specify additional features of the file transfer. Among these are the option to use encryption of data in transit and how long the archive stays on the server before it is removed. In addition, the user can specify the type of archiving scheme that is used, a feature that may be useful for converting files and folders to the receiver's operating system.

I claim:

1. A method of transferring information from a sender to a recipient over an intranet or Internet connection, comprising the steps of:
selecting the information to be transferred by the sender;
entering data relating to the destination of the recipient;
building an archive and transferring the archive to a server on the intranet or Internet;
sending a message to the recipient that contains a link to retrieve the file from the server; and
running the file by the recipient, thereby completing the transfer of the information to the recipient.

2. The method of claim 1, where the information is a file or folder.

3. The method of claim 1, where the message is an email message.

4. The method of claim 1, where the message is a message associated with a chat server or other type of system.

5. The method of claim 1, where the server is co-resident at the location of the sender.

6. The method of claim 1, where the information is encrypted by the sender.

7. The method of claim 1, where the user can specify the type of archive and destination operating system used for the transfer.
